(19) United States
(12) Patent Application Publication
(10) Pub. No.: US 2007/0117562 A1
(43) Pub. Date: May 24, 2007

(54) Apparatus and method for registering location of convergence terminal with multiple interfaces

(75) Inventors: Jae-Jeong Shim, Seongnam-si (KR); Heung-Chul Jung, Suwon-si (KR); Dong-Keon Kong, Suwon-si (KR); Sang-Jun Moon, Yongin-si (KR); Sung-Won Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/603,229

(22) Filed: Nov. 22, 2006

(30) Foreign Application Priority Data
Nov. 24, 2005 (KR) 2005-0112689

(51) Int. Cl. H04Q 7/20

(52) U.S. Cl. 455/433

(57) ABSTRACT

An apparatus and method for registering the location of a multi-interface convergence terminal are provided. In a register for managing location registration information of a multi-interface convergence terminal, upon receipt of a message with the address of an AP using a short-range wireless communication protocol, a signaling processor requests a wired phone number mapped to the AP, generates a message including the wired phone number and sends the message. A register database provides the wired phone number mapped to the AP to the signaling processor and stores the address and of the AP and the wired phone number mapped to the AP address.

### CROSS-REFERENCE TO RELATED APPLICATIONS

This application claims the benefit under 35 U.S.C. § 119(a) of Korean Patent Application Serial No. 2005-112689, filed Nov. 24, 2005 in the Korean Intellectual Property Office, the entire disclosure of which is hereby incorporated by reference.

### BACKGROUND OF THE INVENTION

1. Field of the Invention

The present invention relates to an apparatus and method for registering the location of a convergence terminal supporting short-range wireless communication technology such as Bluetooth and ZigBee, when the convergence terminal is connected to a Public Switched Telephone Network (PSTN) by the short-range wireless communication technology.

The convergence terminal may be a mobile communication terminal with at least two wireless interfaces. The convergence terminal may use mobile communication technology and short-range wireless communication technology such as Bluetooth technology.

That is, the present invention relates to an apparatus and method for registering the location of a convergence terminal using the mobile communication technology and the short-range wireless communication technology, for call termination, when the convergence terminal enters into or moves out of a short-range wireless communication area.

2. Description of the Related Art

FIG. 1 illustrates network connections of a convergence terminal that simultaneously supports existing mobile communication technology and short-range wireless communication technology.

The convergence terminal is connected to a Public Land Mobile Network (PLMN) outdoors by the mobile communication technology. While indoors, it is connected to a PSTN via a Bluetooth Access Point (AP) or to the PLMN by the mobile communication technology as outdoors.

When the convergence terminal enters indoors into a Bluetooth communication area, its subscriber presses a dedicated button or selects a predetermined menu item from a user menu. Upon selection of the button or the menu item, or in the case where the convergence terminal has been set to automatic Bluetooth registration, the convergence terminal periodically scans for a Bluetooth signal. When the Bluetooth signal is detected, the convergence terminal activates a Bluetooth interface, detects a Bluetooth signal from a neighbor Bluetooth AP, and then is connected to the neighbor Bluetooth AP.

Being connected to the Bluetooth AP, which is connected to the PSTN, the convergence terminal can originate and terminate wired calls via the Bluetooth AP.

In the illustrated case of FIG. 1, if the convergence terminal enters indoors and connects to the Bluetooth AP, only a Bluetooth link set-up is performed without any registration procedure.

That is, the connection of the convergence terminal to the Bluetooth AP is not made known to a predetermined node of the PLMN by registration over the PSTN or the PLMN.

Since the convergence terminal originates and terminates calls over the PSTN via the Bluetooth AP but does not register the AP connection in the PLMN, the call origination and termination in the PSTN are independent of those in the PLMN.

Therefore, the convergence terminal is enabled concurrently with the mobile communication technology and the Bluetooth technology indoors. Even when the convergence terminal makes a wired call using the. Bluetooth technology, it keeps its mobile communication interface active.

Despite the advantage of having the ability to originate and terminate a mobile call while a wired call is in progress, keeping the two interfaces active remarkably increases the battery consumption of the convergence terminal.

If a mobile communication signal is weak indoors, a mobile call maybe terminated via the PLMN. The call termination over the PLMN at the sacrifice of transmission and reception of good Bluetooth signals may decrease an incoming call success rate and seriously degrade communication quality.

Therefore, two phone numbers (in other words a mobile phone number and a wired phone number) are needed for the convergence terminal. Because the convergence terminal may use the two interfaces at the same time, a single Identifier (ID) does not suffice.

Accordingly, there is a need for an improved apparatus and method for registering a location of a convergence terminal having multiple interfaces.

### SUMMARY OF THE INVENTION

Exemplary embodiments of the present invention address at least the above problems and/or disadvantages and provide at least the advantages described below. Accordingly, an object of the present invention is to provide an apparatus and method for registering the location of a multi-interface convergence terminal with a network to enable the multi-interface convergence terminal to use two kinds of services via one interface.

The above object is achieved by, for example, providing an apparatus and method for registering the location of a multi-interface convergence terminal.

According to an exemplary aspect of an embodiment of the present invention, in a register for managing location registration information of a multi-interface convergence terminal, upon receipt of a message with the address of an AP using a short-range wireless communication protocol, a signaling processor requests a wired phone number mapped to the AP, generates a message including the wired phone number and sends the message. A register database provides the wired phone number mapped to the AP to the signaling processor and stores the address of the AP and the wired phone number mapped to the AP address.

### BRIEF DESCRIPTION OF THE DRAWINGS

The above and other objects, features and advantages of certain exemplary embodiments of the present invention will become more apparent from the following detailed description when taken in conjunction with the accompanying drawings in which:

FIG. 1 illustrates network connections of a convergence terminal simultaneously supporting existing mobile communication technology and wireless communication technology;

FIG. 2 illustrates a mobile communication technology-based operation according to an exemplary embodiment of the present invention;

FIG. 3 is a block diagram of a register according to an exemplary embodiment of the present invention;

FIG. 4 is a flowchart illustrating an operation of a register according to an exemplary embodiment of the present invention;

FIG. 5 is a flowchart illustrating an operation of a Home Location Register (HLR) according to an exemplary embodiment of the present invention;

FIG. 6 is a flowchart illustrating an operation of a convergence terminal according to an exemplary embodiment of the present invention;

FIG. 7 illustrates fields of a registration message according to an exemplary embodiment of the present invention;

FIG. 8 illustrates a registration code according to an exemplary embodiment of the present invention; and

FIG. 9 is a diagram illustrating a signal flow for a registration operation according to an exemplary embodiment of the present invention.

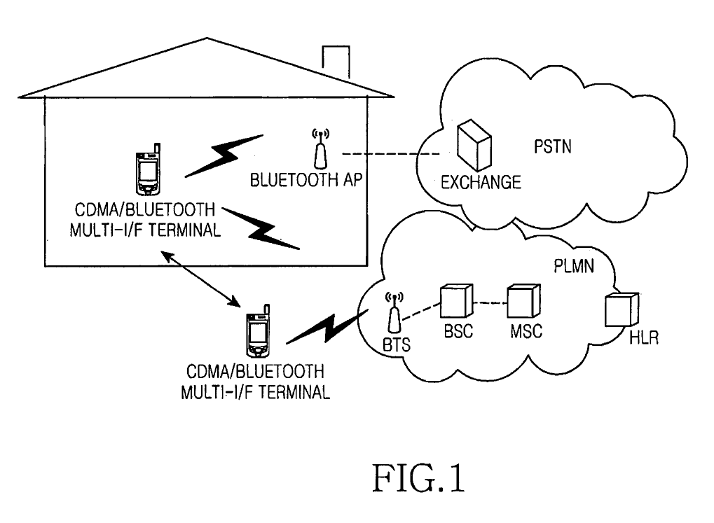

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention are intended to provide an apparatus and method for registering the location of a convergence terminal.

While an exemplary embodiment of the present invention is described in the context of Bluetooth as a short-range wireless communication interface and a mobile communication interface (Code Division Multiple Access 2000 (CDMA 2000)) for outdoor communications, it is to be clearly understood that these are merely exemplary and the present invention is also applicable with other interfaces.

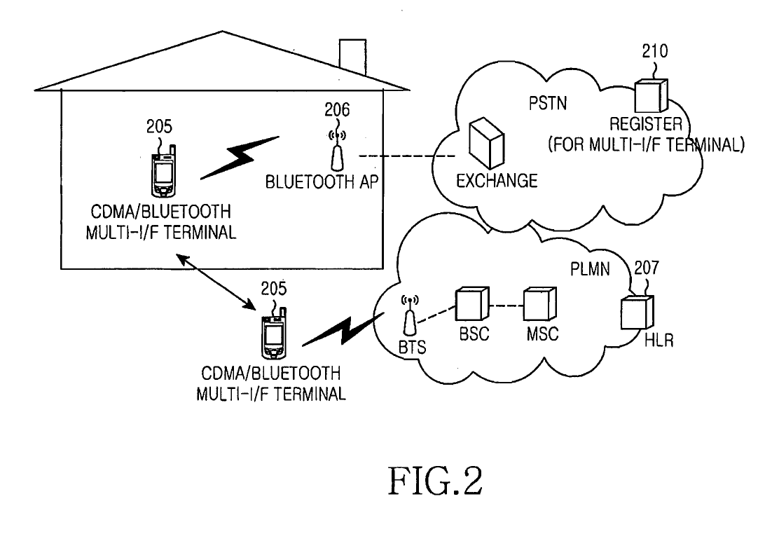

FIG. 2 illustrates a mobile communication technology-based operation according to an exemplary embodiment of the present invention.

Referring to FIG. 2, a convergence terminal 205 comprises a mobile communication interface and a Bluetooth interface. When the convergence terminal is outdoors, it may be connected to a Public Land Mobile Network (PLMN).

When the convergence terminal 205 enters indoors where a Bluetooth AP 206 is located, it deactivates the mobile communication interface and connects to a Public Switched Telephone Network (PSTN) via the Bluetooth interface.

To enable provisioning of two kinds of services via one interface, the convergence terminal 205 registers with a Home Location Register (HLR) 207 and a register 210 so that an incoming call directed to a mobile phone number can be forwarded to a wired phone number as necessary.

The HLR 207 is a system for registering the locations of mobile subscribers and managing them. It manages mobility information, additional service information of the subscribers, and the like.

The register 210 manages PSTN-related information of the convergence terminal 205. Specifically, the register 210 manages information indicating the Bluetooth AP to which the convergence terminal 205 is connected to, and the wired phone number of the convergence terminal.

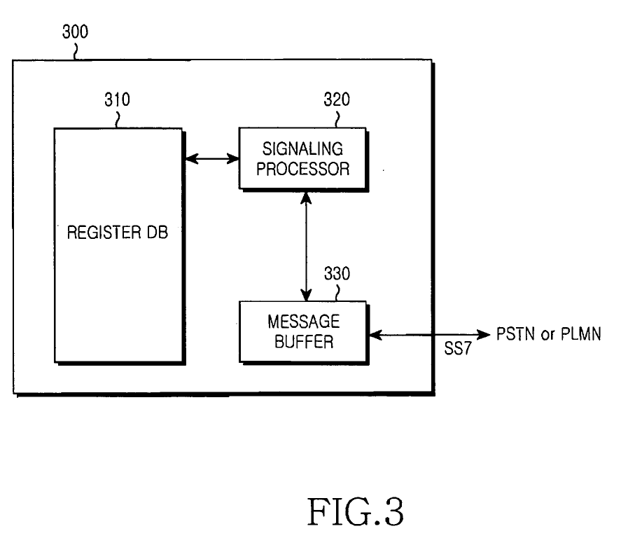

FIG. 3 is a block diagram of a register according to an exemplary embodiment of the present invention.

Referring to FIG. 3, a register 300 exchanges control messages with the PLMN or the PSTN by Signaling System No. 7 (SS7).

A message buffer 330 stores control messages. A signaling processor 320 processes messages received from the networks, or generates new control messages and buffers them in the message buffer 330.

A register DataBase (DB) 310 stores the addresses (BD_ADDR) and wired phone numbers of Bluetooth APs.

The signaling processor 320 receives a control message with the address of a Bluetooth AP, BD_ADDR, requesting the wired phone number of the Bluetooth AP from the HLR, and replies with the wired phone number corresponding to BD_ADDR.

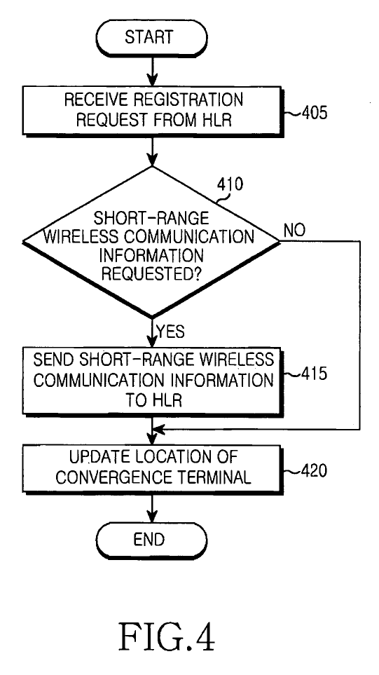

FIG. 4 is a flowchart illustrating an operation of the register according to an exemplary embodiment of the present invention.

Referring to FIG. 4, the register 300 receives a location registration request for the convergence terminal 205 from the HLR 207 in step 405.

In step 410, the register 300 determines whether the location registration request includes a request for information associated with short-range wireless communication, for example, Bluetooth communication.

The Bluetooth communication information request means a request for a wired phone number that the convergence terminal will use by Bluetooth signals. The register 300 has a table comprising a wired phone number mapped to the address of a Bluetooth AP, BD_ADDR, which address was indicated by the request from the HLR 207.

If the information request is included in step 410, the register 300 sends the Bluetooth communication information (in other words, the wired phone number) of the convergence terminal 205 to the HLR 207 in step 415.

In step 420, the register 300 updates the location of the convergence terminal 205 with the received address BD_ADDR of the Bluetooth AP. That is, the register 300 updates the Bluetooth AP connection information of the convergence terminal 205.

On the contrary, in the absence of the information request in step 410, in other words if the HLR 207 already has the wired phone number of the convergence terminal 205, the register 300 updates the location of the convergence terminal 205 with the received address BD_ADDR of the Bluetooth AP and then ends the algorithm.

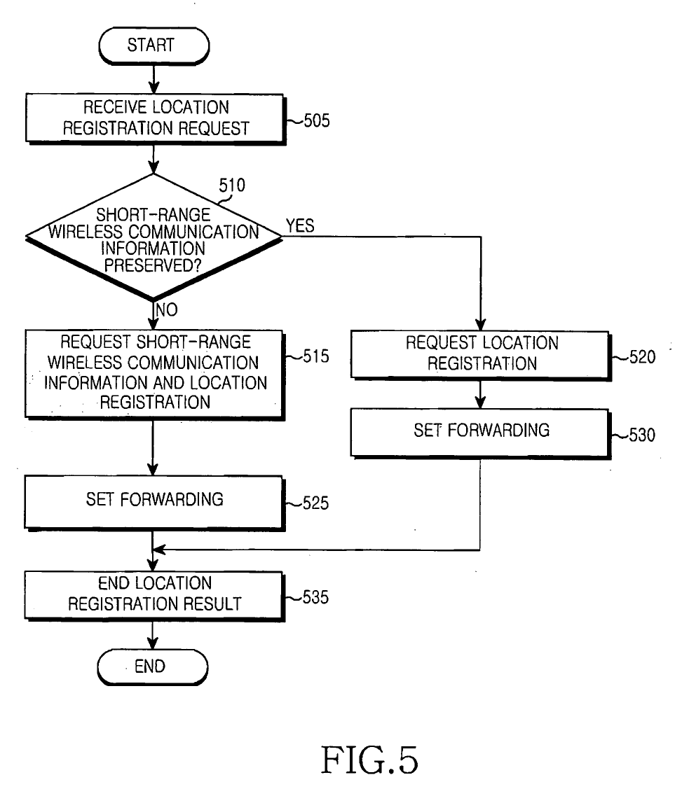

FIG. 5 is a flowchart illustrating an operation of the HLR according to an exemplary embodiment of the present invention.

Referring to FIG. 5, the HLR 207 receives a location registration request from the convergence terminal 205 by a registration message in step 505.

The registration message includes fields with information about a Bluetooth AP to which the convergence terminal 205 is connected.

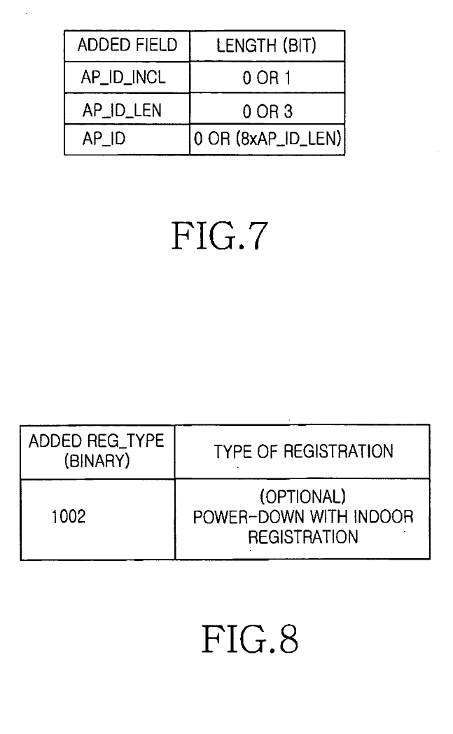

As shown in FIG. 7, the fields are 1-bit AP_ID_INCL, 3-bit AP_ID_LEN, and (8xAP_ID_LEN)-bit AP_ID. AP_ID_INCL indicates whether the AP_ID field is included, AP_ID_LEN indicates the length of the AP_ID field, and AP_ID indicates the address of the Bluetooth AP, BD_ADDR.

As illustrated in FIG. 8, REG_TYPE is set to a new registration code ‘1002’ indicating ‘Power-down with indoor registration’.

When REG_TYPE is 1002, it is mandatory that the registration message includes the AP_ID_INCL, AP_ID_LEN, and AP_ID fields. This will be discussed in greater detail below.

In step 510, the HLR 207 determines whether it has the Bluetooth communication information of the convergence terminal 205. Specifically, the HLR 207 checks whether it has a wired phone number corresponding to BD_ADDR indicated by the registration message.

In the presence of the Bluetooth communication information, the HLR 207 updates the registration information of the convergence terminal 205 and requests the register 300 to register the location of the convergence terminal 205 in step 520. In step 530, the HLR 207 sets call forwarding for the convergence terminal 205 so that a call directed to the mobile phone number of the convergence terminal 205 is forwarded to the wired phone number in step 530.

The HLR 207 notifies the convergence terminal 205 of completion of the location registration in step 535.

In the absence of the Bluetooth communication information in step 510, the HLR 207 requests the Bluetooth communication information and the location registration of the convergence terminal 205 from the register 300 in step 515. That is, the HLR 201 queries the register 300 about the wired phone number of the convergence terminal 205 for Bluetooth communication and registers the location information indicating the Bluetooth AP to which the convergence terminal 205 is currently connected.

In step 525, the HLR 207 receives the Bluetooth communication information from the register 300, updates the registration information of the convergence terminal 205, and sets the call forwarding for the convergence terminal 205 so that a call directed to the mobile phone number is forwarded to the wired phone number.

After step 535 is performed, the HLE 207 ends the algorithm.

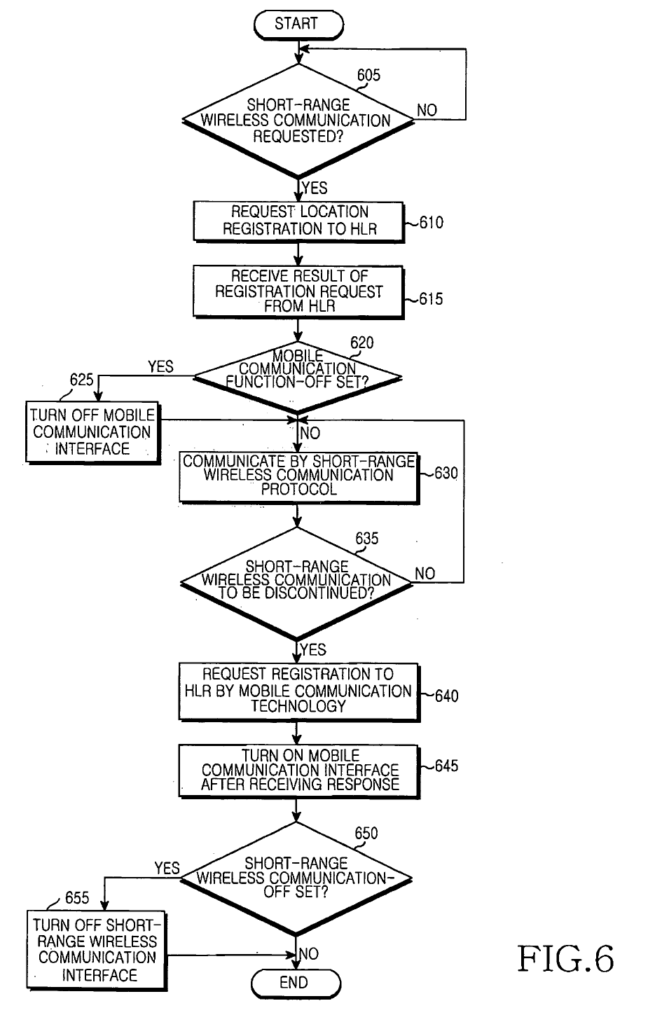

FIG. 6 is a flowchart illustrating an operation of a convergence terminal according to an exemplary embodiment of the present invention.

Referring to FIG. 6, when the convergence terminal 205 enters into a Bluetooth communication area, for example, indoors, the subscriber may press a button or select a menu item from a user menu to initiate Bluetooth registration. Upon selection of the button or the menu item, or in the case where the convergence terminal 205 has been set to automatic Bluetooth registration, the convergence terminal 205 detects a Bluetooth signal by periodic scanning. Thus, the Bluetooth connection request is issued.

Upon request for Bluetooth connection in step 605, the convergence terminal 205 requests location registration from the HLR 207 by a registration message for Bluetooth communication in step 610. The registration message contains the fields that provide information about the Bluetooth AP to which the convergence terminal 205 is connected.

As illustrated in FIG. 7, the fields are 1-bit AP_ID_INCL, 3-bit AP_ID_LEN, and (8xAP_ID_LEN)-bit AP_ID. AP_ID_INCL indicates whether the AP_ID field is included, AP_ID_LEN indicates the length of the AP_ID field, and AP_ID indicates the address of the Bluetooth AP, BD_ADDR.

As illustrated in FIG. 8, REG_TYPE is set to the new registration code “1002” indicating “Power-down with indoor registration.”

When REG_TYPE is 1002, it is mandatory that the registration message includes the AP_ID_INCL, AP_ID_LEN, and AP_ID fields.

The convergence terminal 205 receives the result of the requested location registration in step 615 and determines whether its mobile communication interface function off has been set in step 620.

If the mobile communication interface function off has been set, the convergence terminal 205 turns off the mobile communication interface in step 625 and conducts Bluetooth communication in step 630.

If the mobile communication interface function off has not been set, the convergence terminal conducts Bluetooth communications without turning off the mobile communication interface in step 630.

If the Bluetooth communication is to be discontinued under the circumstances, that is, if the Bluetooth signal from the Bluetooth AP becomes weak and the strength eventually drops to or below a threshold in step 635, the convergence terminal scans mobile communication signals, generates a registration message to access the PLMN, and sends the registration message to the HLR 207 in step 640.

In step 645, the convergence terminal 205 receives a response message for the registration request from the HLR 207 and activates the mobile communication interface.

The registration message may include none of the AP_ID_INCL, AP_ID_LEN and AP_ID fields and REG_TYPE is set to “0001” indicating “Power-up”.

In step 650, the convergence terminal 205 determines whether its Bluetooth interface function off has been set.

If the Bluetooth interface function off has been set, the convergence terminal 205 turns off the Bluetooth interface in step 655 and ends the algorithm.

If the convergence terminal 205 has been set to the automatic Bluetooth registration in step 650, it has to periodically scan Bluetooth signals and thus does not turn off the Bluetooth interface even outdoors.

The registration message sent by the convergence terminal 205 is processed in a typical registration procedure. The moment the mobile communication registration is completed, the convergence terminal 205 is connected to the PLMN and it is now able to originate and terminate mobile calls, acting in the same manner as a general mobile phone.

FIG. 7 illustrates fields of the registration message according to an exemplary embodiment of the present invention.

Referring to FIG. 7, the fields are added to a Registration Message defined by the CDMA standard “Upper Layer (Layer 3) Signaling Standard for CDMA2000 Spread Spectrum Systems” in accordance with exemplary embodiments of the present invention. The fields are 1-bit AP_ID_INCL indicating whether the AP_ID field is included, 3-bit AP_ID_LEN indicating the length of the AP_ID field, and (8xAP_ID_LEN)-bit AP ID indicating an AP ID.

FIG. 8 illustrates the registration code according to an exemplary embodiment of the present invention.

Referring to FIG. 8, the registration code is added to REG_TYPE of the Registration Message defined by the CDMA standard “Upper Layer (Layer 3) Signaling Standard for CDMA2000 Spread Spectrum Systems” in accordance with an exemplary embodiment of the present invention.

The new registration code “1002” is set using a reserved area in REG_TYPE of the CDMA2000 standard in order to deactivate the mobile communication interface when the convergence terminal 205 registers for Bluetooth communications.

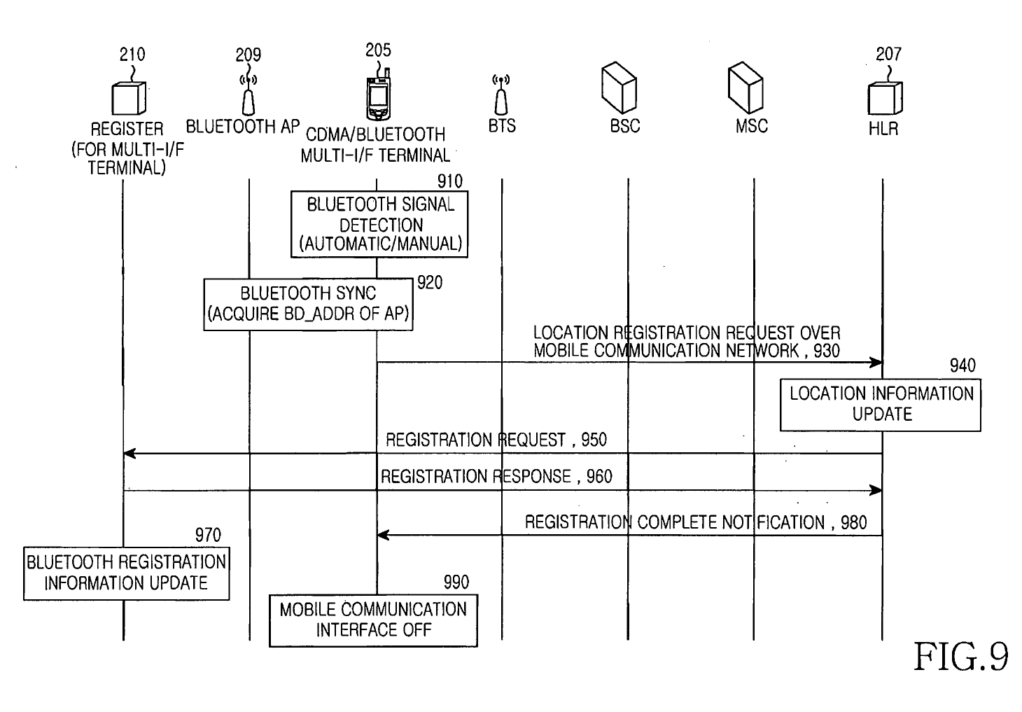

FIG. 9 is a diagram illustrating a signal flow for a registration operation according to an exemplary embodiment of the present invention.

Referring to FIG. 9, when determining to conduct Bluetooth communication, the convergence terminal 205 activates the Bluetooth interface, detects a Bluetooth signal from a neighbor Bluetooth AP 209, and connects to the neighbor Bluetooth AP in step 910.

Upon user selection of a button or a menu item from a user menu or in the case where the convergence terminal 205 has been set to automatic Bluetooth registration, the convergence terminal 205 detects a Bluetooth signal by periodic scanning. In this way, the convergence terminal 205 is connected to the Bluetooth AP.

In step 920, the convergence terminal 205 acquires the address of the Bluetooth AP, BD_ADDR from the Bluetooth AP.

The convergence terminal 205 generates a registration message including BD_ADDR and sends it to the HLR 207 in step 930. The registration message contains the AP_ID_INCL, AP_ID_LEN, and AP_ID fields and has REG_TYPE set to 1002 indicating power-down with indoor registration as illustrated in FIG. 8. When REG_TYPE is 1002, it may be mandatory that the registration message includes the AP_ID_INCL, AP_ID_LEN, and AP_ID fields.

In an exemplary embodiment, power-registration with indoor registration is indicated by setting the AP_ID_INCL field to 1 without adding the new REG_TYPE.

The HLR 207 updates the registration information of the convergence terminal 205, recognizing that the convergence terminal 205 is connected to the Bluetooth AP in step 940.

Also, if the HLR 207 already has the wired phone number of the convergence terminal 205, it sets call forwarding for the convergence terminal 205 so that a call directed to the mobile phone number is forwarded to the wired phone number.

In step 950, the HLR 207 notifies the register 210 that the convergence terminal 205 is connected to the Bluetooth AP, referring to BD_ADDR received by the registration message.

If the HLR does not already have the wired phone number, the HLR 207 receives the wired phone number corresponding to the Bluetooth AP from the register 210 in step 960. Then it can set call forwarding for the convergence terminal 205 so that a call directed to the mobile phone number is forwarded to the wired phone number.

In an exemplary embodiment, the register 210 manages and updates a table having the addresses BD_ADDR and wired phone numbers of Bluetooth APs and other information.

According to exemplary embodiments of the present invention, the register 210 updates information indicating a Bluetooth AP connected to the convergence terminal 205 using BD_ADDR received from the HLR 207 in step 970.

For this purpose, the register 210 may manage the addresses BD_ADDR and wired phone numbers of Bluetooth APs by an automatic/manual registration when the Bluetooth APs are installed.

In step 980, the HLR 207 notifies the convergence terminal 205 that the Bluetooth registration has been completed. Then the convergence terminal 205 deactivates the mobile communication interface in step 990.

Thus, the convergence terminal 205 is now able to originate and terminate wired calls and terminate mobile calls via the Bluetooth interface only.

In an exemplary embodiment, the mobile communication interface may not be set to off upon user selection when the convergence terminal 205 is connected to the Bluetooth AP.

If the automatic Bluetooth registration has been set in step 910, the convergence terminal 205 has to scan Bluetooth signals periodically. Hence, both the mobile communication interface and the Bluetooth interface are used outdoors.

If a ZigBee protocol is used instead of the Bluetooth protocol as a short-range wireless communication protocol, the registration message contains a 64-bit Institute of Electrical and Electronics Engineers (IEEE)-assigned address instead of BD_ADDR.

In accordance with the present invention, A terminal (not shown) comprises an interface module comprising a mobile communication module and a short-range wireless communication module, and a controller for requesting registration of a short-range wireless communication mode by sending a message including information about an Access Point (AP) using the short-range wireless communication protocol when the terminal detects a short-range wireless communication and connects to the short-range wireless communication signal.

The message includes fields comprises at least one of a registration code and the AP information. The registration code comprises an indoor registration code. The AP information comprises at least one of a field indicating whether the AP information is included, a field indicating the length of an address of the AP, and a field indicating the address of the AP. The short-range wireless communication protocol comprises a Bluetooth protocol.

In accordance with exemplary embodiments of the present invention as described above, even when a convergence terminal is located in a mobile communication shadowing area, it can receive mobile communication services by the Bluetooth technology.

Also, as the convergence terminal can receive two kinds of services through one of two interfaces, one phone number suffices and battery consumption is reduced.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A register for managing location registration information of a terminal, comprising:
a signaling processor for transmitting a message including a wired phone number mapped to an Access Point (AP) upon receipt of a request message with the address of the Access Point (AP) of a short-range wireless communication protocol connected to a terminal from a Home Location Register (HLR) to the HLR; and
a register database for providing the wired phone number mapped to the AP to the signaling processor and for storing the address of the AP and the wired phone number mapped to the AP address.

2. The register of claim 1, wherein the short-range wireless communication protocol is a Bluetooth protocol.

3. The register of claim 1, wherein the signaling processor updates the wired phone number mapped to the AP address stored in the register database with the wired phone number included in the request message.

4. A system for registering the location of a terminal, comprising:
a terminal for requesting registration of a communication mode using a short-range wireless communication protocol;
a Home Location Register (HLR) for receiving the registration request from the terminal and for updating a registration information of the terminal in the HLR and transmitting the registration information of the terminal; and
a register for updating a registration information of the terminal in the register using the registration information of the terminal received from the HLR.

5. The system of claim 4, wherein the short-range wireless communication protocol is a Bluetooth protocol.

6. The system of claim 4, wherein the HLR sends a wired phone number to the register when the HLR comprises the wired phone number mapped to an Access Point (AP) using the short-range wireless communication protocol, and further wherein the HLR requests the wired phone number from the register, receives the wired phone number from the register, sets service forwarding for the terminal so that a mobile communication service directed to a mobile phone number of the terminal is forwarded to the wired phone number, and updates the registration information of the terminal when the HLR does not comprise the wired phone number.

7. The system of claim 4, wherein the register provides a wired phone number to the HLR when the register receives a request for the wired phone number mapped to the AP from the HLR, and further wherein, the register updates registration information of the terminal by updating a previously stored wired phone number mapped to the AP with a received wired phone number when the register receives the wired phone number mapped to the AP from the HLR.

8. The system of claim 4, wherein the terminal requests the registration of the communication mode using the short-range wireless communication protocol to the HLR by sending a message including fields comprising at least one of a registration code and information of the AP using the short-range wireless communication protocol.

9. The system of claim 8, wherein the registration code comprises an indoor registration code.

10. The system of claim 8, wherein the fields comprising the information of the AP comprise at least one of a field indicating whether the AP information is included, a field indicating the length of an address of the AP, and a field indicating the address of the AP.

11. A method of registering the location of a terminal, the method comprising:
connecting to an Access Point (AP) of a short-range wireless communication protocol connected to a terminal;
requesting registration of a communication mode using short-range wireless communication protocol to a Home Location Register (HLR); and
receiving a registration result from the HLR.

12. The method of claim 11, wherein the short-range wireless communication protocol comprises a Bluetooth protocol.

13. The method of claim 11, wherein requesting registration comprises sending a message including fields comprising at least one of a registration code and information about the AP.

14. The method of claim 13, wherein the registration code comprises an indoor registration code.

15. The method of claim 13, wherein the information about the AP comprises at least one of a field indicating whether the AP information is included, a field indicating the length of an address of the AP, and a field indicating the address of the AP.

16. A method of registering the location of a terminal in a register, the method comprising:
receiving a request for a wired phone number mapped to an Access Point (AP) of a short-range wireless communication protocol connected to a terminal from a Home Location Register (HLR); and
sending the wired phone number to the HLR.

17. The method of claim 16, further comprising:
receiving the wired phone number mapped to the AP; and
updating a previously stored wired phone number mapped to the AP with the received wired phone number.

18. The method of claim 16, wherein the short-range wireless communication protocol comprises a Bluetooth protocol.

19. A method of registering the location of a terminal in a Home Location Register (HLR), the method comprising:
receiving a message including an address of an Access Point (AP) of a short-range wireless communication protocol from a terminal; and
setting a service forwarding for the terminal to forward a mobile communication service directed to a mobile phone number of the terminal to a wired phone number mapped to the AP, if an HLR already has the wired phone number mapped to the AP.

20. The method of claim 19, further comprising:
requesting the wired phone number from a register if the HLR does not have the wired phone number; and
setting service forwarding for the terminal to forward a mobile communication service directed to the mobile phone number of the terminal to the wired phone number mapped to the AP upon receipt of the wired phone number.

21. The method of claim 19, wherein the short-range wireless communication protocol comprises a Bluetooth protocol.

22. A terminal comprising:
an interface module comprising a mobile communication module and a short-range wireless communication module; and
a controller for requesting registration of a short-range wireless communication mode by sending a message including information about an Access Point (AP) using the short-range wireless communication protocol when the terminal detects a short-range wireless communication and connects to the short-range wireless communication signal.

23. The terminal of claim 22, wherein the message includes fields comprising at least one of a registration code and the AP information.

24. The terminal of claim 23, wherein the registration code comprises an indoor registration code.

25. The terminal of claim 23, wherein the AP information comprises at least one of a field indicating whether the AP information is included, a field indicating the length of an address of the AP, and a field indicating the address of the AP.

26. The terminal of claim 22, wherein the short-range wireless communication protocol comprises a Bluetooth protocol.
